(19) United States
(12) Patent Application Publication
(10) Pub. No.: US 2005/0282058 A1
(43) Pub. Date: Dec. 22, 2005

(54) Fuel cell housing structure

(75) Inventor: Masanari Yanagisawa, Kawasaki-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Nissan Motor Co., Ltd., Yokohama (JP)

(21) Appl. No.: 11/154,955

(22) Filed: Jun. 17, 2005

(30) Foreign Application Priority Data
Jun. 18, 2004 (JP) 2004-181345

(51) Int. Cl. H01M 8/04

(52) U.S. Cl. 429/34; 429/53

(57) ABSTRACT

A fuel cell housing structure with a fuel cell, an electrically insulated housing containing the fuel cell, the housing being surrounding the fuel cell to provide a space surrounding the fuel cell. A vent gas intake port in the housing is connected to the space within the housing surrounding the fuel cell at a location below the fuel cell. A vent gas exhaust port is connected to the space within the housing.

### CROSS-REFERENCE TO RELATED APPLICATIONS

The present application claims priority under 35 U.S.C. § 119 of Japanese Patent Application No. 2004-181345; filed on Jun. 18, 2004, the entire content of which is expressly incorporated by reference herein.

### BACKGROUND OF THE INVENTION

1. Field of the Invention

The invention relates to a fuel cell housing structure, and more specifically to a structure for a ventilated fuel cell housing in which a fuel cell is housed.

2. Description of Related Art

Japanese Laid Open Patent Publication 2002-373685 describes a conventional fuel cell housing structure in which vent gas intake and exhaust ports are connected to the top part of the housing to vent out leaking hydrogen gas which easily accumulates in the top part of the housing in which the fuel cell is housed.

### SUMMARY OF THE INVENTION

The fuel cell housing structure according to the present invention is capable of preventing a reduction in insulation resistance between the fuel cell and housing caused by water entering the housing and flowing off of the fuel cell onto the housing.

The fuel cell housing structure according to the present invention provides a structure housing a fuel cell within a housing whereby the fuel cell is electrically insulated from the housing. A vent gas intake port and a vent gas exhaust port connect to the space within the housing surrounding the fuel cell at a location below the fuel cell in the vertical direction.

Because the vent gas intake and exhaust port, which connect to the space within the housing surrounding the fuel cell, are located at positions below the fuel cell in the vertical direction, even a small amount of water entering the housing from the vent gas intake or exhaust port is prevented from coming into contact with the fuel cell, and thus a momentary reduction in insulation resistance, a reduction which would otherwise occur as a result of water running off of the fuel cell into the housing, is prevented.

Accordingly, the invention contemplates a structure for a fuel cell housing in which a fuel cell, which maintains a high electrical potential when the vehicle is operating, is housed and electrically insulated from the housing by a space between the housing and the fuel cell. The fuel cell may be attached to the floor of the housing through insulated mounts. A vent gas intake port, which directs external air into the space, connects to the bottom part of a side wall of the housing, and a vent gas exhaust port, which vents gas within the space to the external environment, connects to the bottom part of the opposite side wall. The vent gas intake and exhaust ports operate to vent hydrogen, which has leaked out of the fuel cell into the space, to the external region.

According to one version of the present invention, a fuel cell housing structure includes a fuel cell and an electrically insulated housing containing the fuel cell. The housing is arranged to surround the fuel cell and provide a space surrounding the fuel cell. An electrically insulated mount supports the fuel cell above a bottom of the fuel cell. A vent gas intake port is provided in the housing, the vent gas intake port being connected to the space within the housing surrounding the fuel cell at a location below the fuel cell and substantially at a level of the electrically insulated mount. A vent gas exhaust port is provided in the housing, the vent gas exhaust port being connected to the housing at a location above an electrically insulated water-collecting floor connected to the housing.

A vent gas intake space may connect to the vent gas intake port, and a vent gas exhaust space may connect to the vent gas exhaust port. The vent gas intake space and vent gas exhaust space may connect, via connecting passages, to the space within the housing surrounding the fuel cell.

In this case, the vent gas exhaust port may connect to the space within the housing surrounding the fuel cell at a location below the fuel cell and substantially at a level of the electrically insulated mount, the electrically insulated water-collecting floor including a floor of the housing below at least one of the connecting passages and below the vent gas exhaust port.

Alternatively, the electrically insulated mount, the vent gas intake space and the vent gas exhaust space extend below the vent gas exhaust port and the vent gas intake port, such that the electrically insulated water-collecting floor includes a reservoir within the housing and below the connecting passages, the vent gas intake port, and the vent gas exhaust port.

As another alternative, the vent gas exhaust port is connected to the space within the housing surrounding the fuel cell at a location below the fuel cell and substantially at a level of the electrically insulated mount, the vent gas intake space and the vent gas exhaust space being separately formed by a partition wall in the space within the housing surrounding the fuel cell. The vent gas intake space and the vent gas exhaust space are integral to the housing, the connecting passages being formed within the partition wall, and the vent gas intake space and vent gas exhaust space connect to the space within the housing surrounding the fuel cell.

Further alternatively, the vent gas exhaust port may be connected to the space within the housing surrounding the fuel cell at a location below the fuel cell and extend to a separate vent gas exhaust space separated from the housing at a location below a floor of the housing. The electrically insulated water-collecting floor is then formed as a floor of a separate vent gas intake space separated from the housing at a location below a floor of the housing.

Still further alternatively, the vent gas exhaust space may be separated from the space surrounding the fuel cell by the vertical partitioning member, a connecting passage formed within an upper portion of the partitioning member connecting the space surrounding the fuel cell with the vent gas exhaust space. In this case, the vent gas exhaust port may connect to an upper portion of the vent gas exhaust space. The electrically insulated water-collecting floor may be formed as a floor of the vent gas exhaust space separated from the space surrounding the fuel cell by the vertical partitioning member.

According to another version of the present invention, a fuel cell housing structure includes a fuel cell and an electrically insulated housing containing the fuel cell. The housing is arranged to surround the fuel cell and provide a space surrounding the fuel cell, and a vent gas intake port is provided in the housing, the vent gas intake port being connected to the space within the housing surrounding the fuel cell at a location below the fuel cell. A vent gas exhaust port being connected to the space within the housing.

Optionally, the vent gas intake space may connect to the vent gas intake port, and a vent gas exhaust space may connect to the vent gas exhaust port, the vent gas intake and exhaust spaces being connected, via connecting passages, to the space within the housing surrounding the fuel cell.

In this case, a partition wall may be provided in the space within the housing surrounding the fuel cell, the vent gas intake space and the vent gas exhaust space being separately formed by the partition wall in the space within the housing surrounding the fuel cell and being integral to the housing. The connecting passages may be formed within the partition wall, and the vent gas intake and exhaust spaces may be connected to the space within the housing surrounding the fuel cell.

Alternatively, the vent gas intake space and the vent gas exhaust space may be formed separated from the housing at a location below a floor of the housing and external to the space within the housing surrounding the fuel cell. Alternatively or in addition, the vent gas intake space and the vent gas exhaust space may be located below the space within the housing surrounding the fuel cell. Further alternatively or in addition, the vent gas intake port and the vent gas exhaust port may respectively connect to the vent gas intake space and the vent gas exhaust space at a location above a bottom part of the vent gas intake space and the vent gas exhaust space.

According to yet another version of the present invention, a fuel cell housing structure may include a fuel cell, an electrically insulated housing containing the fuel cell, the housing being arranged to surround the fuel cell and provide a space surrounding the fuel cell, and a vent gas intake port connecting to the space within the housing surrounding the fuel cell at a location below the fuel cell. A vent gas exhaust space may be formed beside and opposing the space surrounding the fuel cell by a partitioning member. A connecting passage may be formed within an upper portion of the partitioning member, the connecting passage connecting the space surrounding the fuel cell with the vent gas exhaust space, the vent gas exhaust space being connected to the vent gas exhaust port. In this case, the vent gas exhaust port may connect to an upper portion of the vent gas exhaust space.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a schematic cross sectional view illustrating a first embodiment of the fuel cell housing structure;

FIG. 2 is a schematic cross sectional view illustrating a second embodiment of the fuel cell housing structure;

FIG. 3 is a schematic cross sectional view illustrating a third embodiment of the fuel cell housing structure;

FIG. 4 is a schematic cross sectional view illustrating a fourth embodiment of the fuel cell housing structure; and

FIG. 5 is a schematic perspective view illustrating a fifth embodiment of the fuel cell housing structure.

### DETAILED DESCRIPTION OF THE PREFERRED EMBODIMENTS

The following will explain, with reference to the above-described drawings, preferred embodiments of the present invention, in which like characters represent like elements. The particulars shown herein are by way of illustrative example of the embodiments of the invention only and are presented in the cause of providing what is believed to be the most useful and readily understood description of the principles and conceptual versions of the present invention. In this regard, no attempt is made to show structural details of the invention in more detail than is necessary for the fundamental understanding of the present invention, the description taken with the drawings making apparent to those skilled in the art how the several forms of the present invention may be embodied in practice.

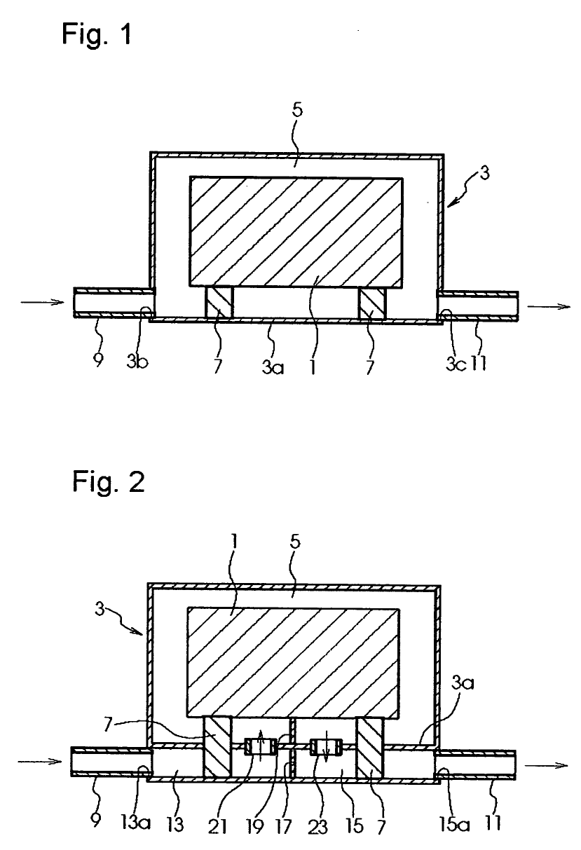

FIG. 1 is a schematic cross sectional view of a first embodiment of the fuel cell housing structure as specified by the fuel cell housing structure according to the invention. A fuel cell 1, which maintains a relatively high electrical potential when the vehicle is running, is sealed within an electrically-grounded case (or housing) 3 with a space 5 (buffer space or clearance) being provided between the housing 3 and external parts of the fuel cell 1. The fuel cell 1 is installed within the housing 3 on a floor part 3a through insulated mounts 7, thereby forming a structure that electrically insulates the fuel cell 1 from the housing 3.

As FIG. 1 illustrates, a port orifice 3b is formed in the lower portion of the left side wall of the housing 3, and connects to a ventilation gas intake port 9 (hereafter referred to as “intake port 9”) which allows the external air to enter the space 5. Also, a port orifice 3c is formed in the lower portion of the right side wall of the housing 3, and connects to the vent gas exhaust port 11 (hereafter referred to as “exhaust port 11”) which allows gas in the space 5 to be discharged into the external environment.

The fuel cell 1 is separated from the floor 3a of the housing 3 by the insulated mounts 7 which allow the intake port 9 and the exhaust port 11 to connect to the housing 3 in proximity to the floor 3a beneath the fuel cell 1.

The intake port 9 and exhaust port 11 form a ventilation mechanism able to expel hydrogen gas which has leaked from the fuel cell 1 and accumulated in the space 5. Ventilation air entering the space 5 from the intake port 9 mixes with hydrogen in the space 5 and exits the housing 3 from the exhaust port 11. Furthermore, a ventilation fan may also be installed in any of the present embodiments, if required, as a ventilation mechanism.

Water temporarily entering the housing 3 from the intake port 9 and the exhaust port 11 (as a result of the fuel cell-equipped vehicle being driven in the rain, for example) is prevented from coming into contact with the fuel cell 1, which maintains a relatively high electrical potential, because the first embodiment disposes the intake port 9 and the exhaust port 11 below the fuel cell 1. Such structure prevents momentary reductions in insulation resistance which would otherwise occur as a result of water entering the housing 3 and flowing off of the fuel cell 1, which is electrically insulated and has a high electrical potential, onto the electrically-grounded housing 3.

In other words, to prevent the lowering of electrical resistance between a housing and a fuel cell, a fuel cell 1, which maintains a high electrical potential when the vehicle to which it is installed is operating, is housed within an electrically insulated and sealable housing 3 so as to provide a space 5 between the housing 3 and the external part of the fuel cell 1. The fuel cell 1 is installed to a floor 3a of the housing 3 through insulated mounts 7. A vent gas inlet port 9, which directs external air into the space 5, connects to the bottom part of a side wall of the housing 3, and a vent gas exhaust port 11, which vents gas within the space 5 to the external environment, is connected to the bottom part of the opposite side wall. The vent gas inlet and outlet ports 9 and 11, which are located at positions below the fuel cell 1, allow hydrogen, which has leaked out of the fuel cell 1 into the space 5, to be discharged to the external region.

Accordingly, the vent gas intake port 9 is connected to the space 5 within the housing 3 surrounding the fuel cell 1 at a location below the fuel cell 1 and substantially at a level of the electrically insulated mount 7, and the vent gas exhaust port 11 is connected to the housing 3 at a location above an electrically insulated water-collecting floor, in this configuration the bottom floor of the housing 3, e.g., near the right-side mount 7.

The reference characters shown in the remaining figures refer to the same elements identified by those characters in FIG. 1. FIG. 2 is a schematic, cross sectional view illustrating a second embodiment of the fuel housing structure. As shown in FIG. 2, this embodiment provides a vent gas intake space 13 and a vent gas exhaust space 15 disposed below the floor 3a. The floor 3a thus serves as a partition between the space 5 and the region including the vent gas intake space 13 and vent gas exhaust space 15. The vent gas intake space 13 and vent gas exhaust space 15 are mutually separated by partition wall 17 as integral spaces of housing 3.

A partition wall 19 divides the space 5 into left and right spaces below the fuel cell 1 on generally the same plane as that of the partition wall 17. A connecting passage 21 connects the vent gas intake space 13 and the space 5 adjacent to the partition walls 17 and 19, and a connecting passage 23 connects the vent gas exhaust space 15 and the space 5 adjacent to the partition walls 17 and 19.

The partition wall 19 may be made of an electrically-insulating material known to those skilled in the art. Also, the insulating mount 7 passes through the floor 3a of the housing 3 and installs to the floor part of the vent gas intake space 13 and vent gas exhaust space 15.

A port orifice 13a is provided on the left side of the vent gas intake space 13 as shown in FIG. 2, and forms a connecting passage to the intake port 9. Furthermore, a port orifice 15a is provided on the right side of the vent gas exhaust space 15 as shown in FIG. 2, and forms a connecting passage to the exhaust port 11.

Even if water should enter the housing 3 from the intake port 9 or the exhaust port 11, the second embodiment structure makes it difficult for that water to enter the space 5, in which the fuel cell 1 is housed, by allowing the water to accumulate within the vent gas intake space 13 and the vent gas exhaust space 15. Compared to the first embodiment, this structure is able to further prevent water from contacting the fuel cell 1, and to further prevent momentary reductions in insulation resistance between the fuel cell 1 and the housing 3.

This structure directs water, which may enter from the intake port 9 and the exhaust port 11, to accumulate in the vent gas intake space 13 and the vent gas exhaust space 15 which are separated from the space 5 by a partitioning member (floor 3a), and as a result prevents the fuel cell 1 from being flooded. Temporary reductions in insulation resistance are thus avoided, even in cases where the water within the spaces 13 and 15 becomes displaced due to the fuel-cell equipped vehicle accelerating or turning.

Accordingly, the vent gas intake port 9 is connected to the space 5 within the housing 3 surrounding the fuel cell 1 at a location below the fuel cell 1 and substantially at a level of the electrically insulated mount 7, and the vent gas exhaust port 11 is connected to the housing 3 at a location above an electrically insulated water-collecting floor, in this configuration the bottom floor of the housing 3, e.g., near the right-side mount 7. The vent gas exhaust port 11 is connected to the space 5 within the housing 3 surrounding the fuel cell 1 at a location below the fuel cell 1 and substantially at a level of the electrically insulated mount 7. The electrically insulated water-collecting floor includes a floor of the housing 3 below at least one of the connecting passages 23 and below the vent gas exhaust port 11 and/or orifice 15a.

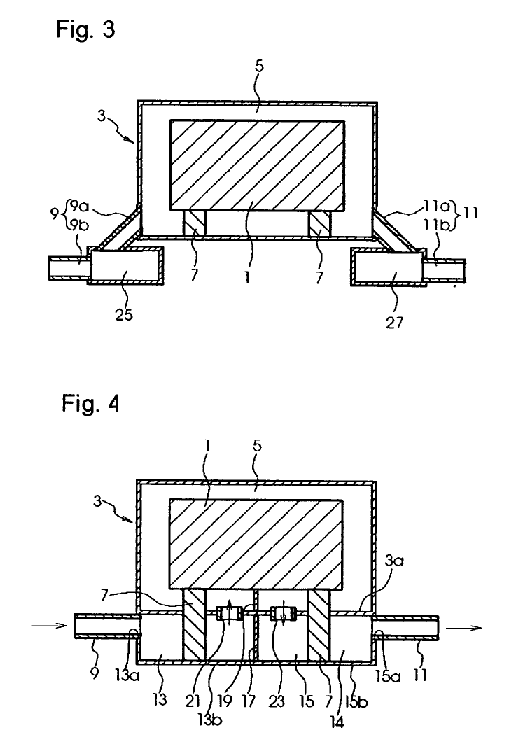

FIG. 3 is a schematic cross sectional view describing a third embodiment of the fuel cell housing structure according to the invention. In this embodiment, the intake port 9 includes a down-flow intake duct 9a which inclines downward from the left side (as viewed in FIG. 3) of the housing 3, the lower end of the down-flow intake duct 9a connecting to the left side of the top of a gas intake space 25 (as viewed in FIG. 3). Furthermore an up-flow intake duct 9b, which is formed as part of the exhaust port 9, connects to the left side (as viewed in FIG. 3) of the vent gas intake space 25.

In addition, the exhaust port 11 includes a down-flow exhaust duct 11a which inclines downward from the right side (as viewed in FIG. 3) of the housing 3, the lower end of the downstream exhaust duct 11a connecting to the right side of the top of vent gas exhaust space 27 (as viewed in FIG. 3). Furthermore, an up-flow exhaust duct 11b, which is formed as part of the exhaust port 11, connects to the right side (as viewed in FIG. 3) of the vent gas exhaust space 27. The ducts 9a, 11a are connecting passages.

In other words, the vent gas intake space 25 and the vent gas exhaust space 27 are each formed separately from (while in communication with) the housing 3 and the space 5 therein.

In a similar manner to the second embodiment, the third embodiment directs water entering from the down-flow intake duct 9a of the intake port 9 or the down-flow exhaust duct 11b of the exhaust port 11 to accumulate in the vent gas intake space 25 or the vent gas exhaust space 27, and provides a configuration that, operating in a similar manner as that of the second embodiment, makes it difficult for water to enter the space 5.

Accordingly, the vent gas intake port 9 is connected to the space 5 within the housing 3 surrounding the fuel cell 1 at a location below the fuel cell 1 and substantially at a level of the electrically insulated mount 7, and the vent gas exhaust port 11 is connected to the housing 3 at a location above an electrically insulated water-collecting floor, in this configuration the bottom of the vent gas exhaust space 27. The vent gas exhaust port 11 (duct 11a) is connected to the space 5 within the housing 3 surrounding the fuel cell 1 at a location below the fuel cell 1 and extends to a separate vent gas exhaust space 27 separated from the housing 3 at a location below a floor of the housing 3, and the electrically insulated water-collecting floor is formed as a floor of a separate vent gas intake space 25 separated from the housing 3 at a location below a floor of the housing 3.

FIG. 4 is a schematic cross sectional view describing a fourth embodiment of the fuel cell housing structure according to the invention. This embodiment forms the vent gas intake space 13 and the vent gas exhaust space 15 to a larger dimension along the vertical axis (i.e., along a plane generally parallel to partition walls 17 and 19), as viewed in FIG. 4, as compared to that of the second embodiment shown in FIG. 2. In this fourth embodiment, the intake port 9 and the exhaust port 11 connect to the respective upper parts of the spaces 13 and 15; that is, the intake port 9 and the exhaust port 11 connect to the upper parts of the spaces 13 and 15 at a location further above the floor parts 13b and 15b.

The larger dimension along the vertical axis helps creates a reservoir 14 within the housing 3 for accumulating water. In addition to providing a similar operation as that of the second embodiment, the fourth embodiment further promotes the accumulation of water in the vent gas intake and exhaust spaces 13 and 15 due to the intake and the exhaust ports 9 and 11 being located at a further distance away from the floor parts 13b and 15b of the vent gas intake and exhaust spaces 13 and 15, and thus more effectively prevents water from entering the space 5.

Accordingly, the vent gas intake port 9 is connected to the space 5 within the housing 3 surrounding the fuel cell 1 at a location below the fuel cell 1 and substantially at a level of the electrically insulated mount 7, and the vent gas exhaust port 11 is connected to the housing 3 at a location above an electrically insulated water-collecting floor, in this configuration the bottom floor parts 15b or reservoir 14, e.g., near the right-side mount 7. The electrically insulated mount 7, the vent gas intake space 13 and the vent gas exhaust space 15 extend below the vent gas exhaust port 11 and the vent gas intake port 9, such that the electrically insulated water-collecting floor 15b includes a reservoir 14 within the housing and below the connecting passages 21, 23, the vent gas intake port 9, and the vent gas exhaust port 11.

For each of the second and fourth embodiments, the vent gas exhaust port 11 is connected to the space 5 within the housing 3 surrounding the fuel cell 1 at a location below the fuel cell 1 and substantially at a level of the electrically insulated mount 7, the vent gas intake space 13 and the vent gas exhaust space 15 are separately formed by a partition wall 3a in the space within the housing 3 surrounding the fuel cell 1, the vent gas intake space 13 and the vent gas exhaust space 15 are integral to the housing 3, the connecting passages 21, 23 are formed within the partition wall 3a, and the vent gas intake space 13 and vent gas exhaust space 15 connect to the space 5 within the housing 3 surrounding the fuel cell 1.

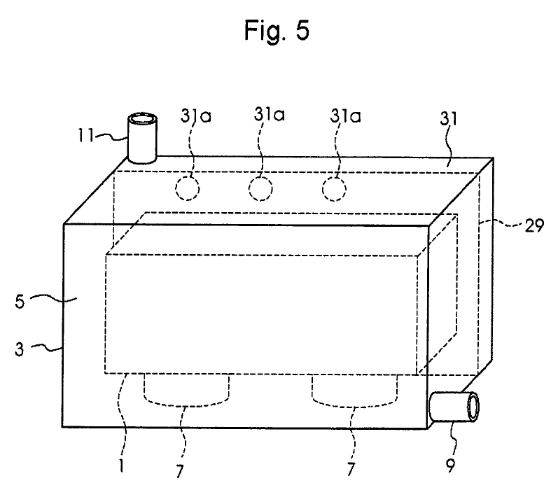

FIG. 5 is a schematic perspective view describing a fifth embodiment of the fuel cell housing structure. In this embodiment, only the intake port 9 is connected to the space 5 surrounding the fuel cell 1 at the lower right side of the housing 3 (as viewed in FIG. 5) in which the fuel cell 1 is housed. Similar to the first embodiment, the intake port 9 is located below the fuel cell 1 on the side wall of the housing and in proximity to the front side of the housing 3 (i.e., in proximity to the side of the housing perceived by one viewing FIG. 5 to be closest to him/her), although it is readily appreciable by those skilled in the art that the intake port 9 may be located below the fuel cell at any reasonable location on the housing 3.

A gas exhaust space 31 is formed by a partitioning member in the form of a partition plate 29 located within the space 5 in the rearward part of the housing as viewed in FIG. 5. A plurality of vent ports 31a, which are formed in the upper portion of the partition plate 29 as upper connecting passages, connect the space 5 to the gas exhaust space 31. Moreover, the exhaust port 11 connects to the left side of the top of the gas exhaust space 31 at the part of the housing opposite to the intake port 9 as viewed in FIG. 5.

The plurality of vent ports 31a formed in the partition plate 29 are aligned in the lengthwise direction of the housing 3 (the left-right direction in FIG. 5) at locations closer to the exhaust port 11 than to the intake port 9.

Vent air entering the space 5 from the intake port 9, along with hydrogen which has leaked into the space 5 from the fuel cell 1, flows into the gas exhaust space 31 through the vent ports 31a, and from the gas exhaust space 31 to the external region through the exhaust port 11.

This embodiment is able to prevent water, which has entered from the external region through the intake port 9, from coming into contact with the fuel cell 1, which has a high electrical potential, because the intake port 9 is located at a position below the fuel cell 1 in a similar configuration to the first embodiment. This embodiment is thus able to prevent momentary reductions in insulation resistance which would otherwise occur as a result of water flowing off of the fuel cell 1, which maintains a high electrical potential and is electrically insulated from the housing 3, to the housing 3 which is electrically grounded.

Furthermore, by locating the vent ports 31a within the upper portion of the housing, agitation of the hydrogen in the space 5 that results from air entering from the lowly-positioned intake port 9 has the effect of promoting the flow of hydrogen through the vent ports 31a into the exhaust space 31, and into the external region in a highly diluted state, through the exhaust port 11.

This structure prevents water, which enters from the vent gas intake port into the space surrounding the fuel cell, from coming into contact with the fuel cell, promotes hydrogen agitation in the region extending from the vent gas intake port to the connecting passages caused by the air coming into the space from the lower positioned vent gas intake port, and efficiently discharges hydrogen, in a diluted state, from the gas exhaust space into the region external to the housing, through the vent gas exhaust port.

Hydrogen accumulating within the upper portion is able to be efficiently discharged into the region external to the housing due to the vent gas exhaust port being located at the upper portion of the gas exhaust space.

Accordingly, the vent gas intake port 9 is connected to the space 5 within the housing 3 surrounding the fuel cell 1 at a location below the fuel cell 1 and substantially at a level of the electrically insulated mount 7, and the vent gas exhaust port 11 is connected to the housing 3 at a location above an electrically insulated water-collecting floor, in this configuration the bottom floor of the gas exhaust space 31. The vent gas exhaust space 31 is separated from the space 5 surrounding the fuel cell 1 by a vertical partitioning member 29, and a connecting passage 31a formed within an upper portion of the partitioning member 29 connects the space 5 surrounding the fuel cell 1 with the vent gas exhaust space 31.

The vent gas exhaust port 11 connects to an upper portion of the vent gas exhaust space 31. The electrically insulated water-collecting floor is formed as a floor of the vent gas exhaust space 31 separated from the space 5 surrounding the fuel cell 1 by the vertical partitioning member 29.

According to the various embodiments (features of which can be combined), when the vent gas intake space is connected to the vent gas intake port, and the vent gas exhaust space being connected to the vent gas exhaust port, and each of these spaces is connected to the space surrounding the fuel cell within the housing, it is then difficult for water, which has entered from the vent gas intake port and vent gas exhaust port and accumulated in the vent gas intake space and vent gas exhaust space, to enter the space around the fuel cell.

Further according to the various embodiments, when the vent gas intake and exhaust spaces are formed as spaces integral to the housing and separated by a partition wall formed in the space within the housing surrounding the fuel cell, and when connecting passages are provided in the partition wall that connect the vent gas intake and exhaust spaces to the space within the housing surrounding the fuel cell, it is also then difficult for water, which has accumulated in the vent gas intake space and vent gas exhaust space from the intake and exhaust ports, to enter the space surrounding the fuel cell.

Alternatively or in addition, according to the various embodiments, when the vent gas intake space and vent gas exhaust space are placed at locations separated from the space within the housing and detached from the housing, it is also then difficult for water which has accumulated in the vent gas intake space and vent gas exhaust space from the intake and exhaust ports to enter the space surrounding the fuel cell.

Alternatively or in addition, according to the various embodiments, when the vent gas intake and exhaust spaces are placed at locations below the space within the housing it is difficult for water, which has accumulated in the vent gas intake space and vent gas exhaust space, to enter the space surrounding the fuel cell.

Alternatively or in addition, according to the various embodiments, the accumulation of water in the vent gas intake space and vent gas exhaust space is permitted, and the invasion of water into the space surrounding the fuel cell is prevented, by locating the vent gas intake port and vent gas exhaust port above the bottom portion of the vent gas intake and exhaust spaces, thus forming a structure which clearly separates the vent gas intake and exhaust ports from the bottom portions of the vent gas intake and exhaust spaces.

Alternatively, or in addition, according to the various embodiments, the fuel cell may be housed within and electrically insulated from the housing, the vent gas intake port connecting to the space within the housing surrounding the fuel cell is located below the fuel cell. In this housing, the gas exhaust space can be formed by a partitioning member opposing the space surrounding the fuel cell, with connecting passages provided on the upper portion of the partitioning member connect the space surrounding the fuel cell with the vent gas exhaust space, and the vent gas exhaust port is connected to the gas exhaust space.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its versions. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims. Alternative structures discussed for the purpose of highlighting the invention's advantages do not constitute prior art unless expressly so identified. No one or more features of the present invention are necessary or critical unless otherwise specified.

1. A fuel cell housing structure comprising:
a fuel cell;
an electrically insulated housing containing the fuel cell, the housing being arranged to surround the fuel cell and provide a space surrounding the fuel cell;
an electrically insulated mount for supporting the fuel cell above a bottom of the fuel cell;
a vent gas intake port provided in the housing, the vent gas intake port being connected to the space within the housing surrounding the fuel cell at a location below the fuel cell and substantially at a level of the electrically insulated mount; and
a vent gas exhaust port provided in the housing, the vent gas exhaust port being connected to the housing at a location above an electrically insulated water-collecting floor connected to the housing.

2. The fuel cell housing structure according to claim 1, wherein
a vent gas intake space connects to the vent gas intake port,
a vent gas exhaust space connects to the vent gas exhaust port, and
the vent gas intake space and vent gas exhaust spaces connect, via connecting passages, to the space within the housing surrounding the fuel cell.

3. The fuel cell housing structure according to claim 2, wherein
the vent gas exhaust port is connected to the space within the housing surrounding the fuel cell at a location below the fuel cell and substantially at a level of the electrically insulated mount, the electrically insulated water-collecting floor comprises a floor of the housing below at least one of the connecting passages and below the vent gas exhaust port.

4. The fuel cell housing structure according to claim 2, wherein
the electrically insulated mount, the vent gas intake space and the vent gas exhaust space extend below the vent gas exhaust port and the vent gas intake port, such that the electrically insulated water-collecting floor comprises a reservoir within the housing and below the connecting passages, the vent gas intake port, and the vent gas exhaust port.

5. The fuel cell housing structure according to claim 2, wherein
the vent gas exhaust port is connected to the space within the housing surrounding the fuel cell at a location below the fuel cell and substantially at a level of the electrically insulated mount, the vent gas intake space and the vent gas exhaust space are separately formed by a partition wall in the space within the housing surrounding the fuel cell, the vent gas intake space and the vent gas exhaust space are integral to the housing, the connecting passages are formed within the partition wall, and the vent gas intake space and vent gas exhaust space connect to the space within the housing surrounding the fuel cell.

6. The fuel cell housing structure according to claim 2, wherein
the vent gas exhaust port is connected to the space within the housing surrounding the fuel cell at a location below the fuel cell and extends to a separate vent gas exhaust space separated from the housing at a location below a floor of the housing, and the electrically insulated water-collecting floor is formed as a floor of a separate vent gas intake space separated from the housing at a location below a floor of the housing.

7. The fuel cell housing structure according to claim 2, further comprising:
a vertical partitioning member, the vent gas exhaust space being separated from the space surrounding the fuel cell by the vertical partitioning member; and
a connecting passage formed within an upper portion of the partitioning member, the connecting passage connecting the space surrounding the fuel cell with the vent gas exhaust space.

8. The fuel cell housing structure according to claim 7, wherein
the vent gas exhaust port connects to an upper portion of the vent gas exhaust space.

9. The fuel cell housing structure according to claim 7, wherein
the electrically insulated water-collecting floor is formed as a floor of the vent gas exhaust space separated from the space surrounding the fuel cell by the vertical partitioning member.

10. A fuel cell housing structure comprising:
a fuel cell;
an electrically insulated housing containing the fuel cell, the housing being arranged to surround the fuel cell and provide a space surrounding the fuel cell;
a vent gas intake port provided in the housing, the vent gas intake port being connected to the space within the housing surrounding the fuel cell at a location below the fuel cell; and
a vent gas exhaust port being connected to the space within the housing.

11. The fuel cell housing structure according to claim 10, further comprising:
a vent gas intake space connected to the vent gas intake port; and
a vent gas exhaust space connected to the vent gas exhaust port,
the vent gas intake and exhaust spaces being connected, via connecting passages, to the space within the housing surrounding the fuel cell.

12. The fuel cell housing structure according to claim 11, further comprising:
a partition wall in the space within the housing surrounding the fuel cell, the vent gas intake space and the vent gas exhaust space being separately formed by the partition wall in the space within the housing surrounding the fuel cell and being integral to the housing, the connecting passages being formed within the partition wall, and the vent gas intake and exhaust spaces being connected to the space within the housing surrounding the fuel cell.

13. The fuel cell housing structure according to claim 12, wherein
the vent gas intake space and the vent gas exhaust space are formed separated from the housing at a location below a floor of the housing and external to the space within the housing surrounding the fuel cell.

14. The fuel cell housing structure according to claims 12, wherein
the vent gas intake space and the vent gas exhaust space are located below the space within the housing surrounding the fuel cell.

15. The fuel cell housing structure according to claim 12, wherein
the vent gas intake port and the vent gas exhaust port respectively connect to the vent gas intake space and the vent gas exhaust space at a location above a bottom part of the vent gas intake space and the vent gas exhaust space.

16. A fuel cell housing structure comprising:
a fuel cell;
an electrically insulated housing containing the fuel cell, the housing being arranged to surround the fuel cell and provide a space surrounding the fuel cell;
a vent gas intake port connecting to the space within the housing surrounding the fuel cell at a location below the fuel cell;
a partitioning member, a vent gas exhaust space being formed beside and opposing the space surrounding the fuel cell by the partitioning member; and
a connecting passage formed within an upper portion of the partitioning member, the connecting passage connecting the space surrounding the fuel cell with the vent gas exhaust space, the vent gas exhaust space being connected to a vent gas exhaust port.

17. The fuel cell housing structure according to claim 16, wherein
the vent gas exhaust port connects to an upper portion of the vent gas exhaust space.
